(19) United States
(12) Patent Application Publication
(10) Pub. No.: US 2010/0113692 A1
(43) Pub. Date: May 6, 2010

(54) Apparatus for Continuous Production of Partially Polymerized Compositions

(76) Inventors: James E. McGuire, JR., Westerville, OH (US); Andrew C. Strange, Worthington, OH (US); Daniel E. Lamone, Dublin, OH (US)

Correspondence Address: THE GRIFFITH LAW FIRM, A P.C., 991C Lomas Santa Fe Drive, Suite 450, Solana Beach, CA, 92075, US

(21) Appl. No.: 12/264,576

(22) Filed: Nov. 4, 2008

(51) Int. Cl. C08F 2/01

(52) U.S. Cl. 525/52; 525/53

(57) ABSTRACT

In one embodiment, an apparatus for continuous production of a partially polymerized composition comprises: a reactor for formation of monomer to be partially polymerized; and a polymerization reactor for continuously receiving the monomer to be partially polymerized from the reactor in which it is formed and partially polymerizing the monomer. In another embodiment, an apparatus for continuous production of a partially polymerized composition comprises: a polymerization reactor for continuously receiving monomer to be partially polymerized and for partially polymerizing the monomer therein, wherein the polymerization reactor comprises an essentially straight tube for a heating portion and wherein the heating portion is essentially free of internal mixing apparatus.

### BACKGROUND OF THE INVENTION

The present invention relates generally to apparatus for continuous production of partially polymerized compositions.

Polymers form the basis for many important materials. For example, adhesives are one important type of material typically based on polymers. Adhesives can be provided in various forms for application, often depending on how polymers on which they are based are themselves formed. For example, polymer-based adhesives can be prepared and provided in organic solvent for application, after which time the solvent is removed. Polymer-based adhesives can also be prepared and applied without use of organic solvent—for example, as in the case of hot-melt adhesives (i.e., where the adhesive is substantially polymerized prior to its application to a substrate) or web-polymerized adhesives (i.e., where the adhesive is substantially polymerized after its application to a substrate).

Methods for preparation of polymers and materials (e.g., adhesives) based thereupon can be performed in a continuous or batch-wise manner. In contrast to continuous web-polymerized methods, conventional methods of batch polymerization of adhesives and methods of continuous production of hot-melt adhesives typically involve running of an initial polymerization reaction to at least near complete conversion, and often complete conversion, of the monomer to polymer. In both cases, the adhesive is substantially polymerized prior to its application to a substrate as compared to web-polymerized adhesives (i.e., where the adhesive is substantially polymerized after its application to a substrate, as discussed above).

Limitations of hot-melt processing methods and resulting materials are known to those of ordinary skill in the art. Limitations associated with batch processing methods, which often utilize solvents (i.e., water or organic solvents), are also known to those of ordinary skill in the art. Notably, use of solvents with batch processing methods, particularly organic solvents, is undesirable from an environmental, safety, and economic standpoint; and, it is becomingly increasingly more so with time. For example, solvent-based batch polymerization of (meth)acrylates typically requires use of large and costly processing equipment in order to safely dissipate heat arising from the exothermic polymerization reaction. In addition, solvents used during the polymerization reaction must then typically be removed from the polymerized composition. This removal process undesirably increases processing time and cost and poses environmental challenges. Thus, alternative methods for production of polymers are desirable.

In addition to the need for alternative processing methods, a need for alternative processing equipment also exists. Conventional polymerization reactors, such as those used to partially or completely polymerize (meth)acrylates, typically suffer from poorly designed heat transfer systems. As such, much of their design hinges on slowly introducing free radicals during polymerization of (meth)acrylate monomers so as to better control the significant exothermic reaction and allow enough time for removal of heat generated by that exothermic reaction. U.S. Pat. No. 3,310,600; U.S. Pat. No. 4,016,348; U.S. Pat. No. 4,402,914; and U.S. Pat. No. 5,726,258, among many other documents, discuss the problem of effectively dissipating the heat of exothermic reactions in continuous polymerization processes and apparatus.

For example, U.S. Patent Publication No. 2006/0036047 describes a loop reactor for carrying out continuous polymerization reactions. As discussed in the background therein, bulk polymerization of (meth)acrylates is possible only to a limited extent in continuous stirred-tank reactors due to the relatively high degree of heat liberation during rapid polymerization reactions, which creates risk of an uncontrolled run-through. It is, thus, stated to be preferable to use reactors with a larger specific heat exchange area, such as tubular, Taylor, or loop reactors, for continuous modes of operation. Loop reactors are described to be predominantly used for such reactors in order to achieve a narrow molecular weight distribution in the resulting (meth)acrylate. In view of those considerations, loop reactors described in U.S. Patent Publication No. 2006/0036047 include a complex three-dimensional tubular loop. Use of such loop reactors is stated to provide thorough transverse mixing without the addition of any static mixing units, resulting in low molecular weight polymers having a narrow molecular weight distribution.

U.S. Pat. No. 6,399,031 (Hermann et al.) is directed toward a curved single-pass tubular reactor (which ideally functions as a “plug flow reactor”) for continuous polymerization processes. Unlike in the loop reactors described in U.S. Patent Publication No. 2006/0036047, no return flow (which provides a recycle/loop component) is present in the tubular reactors of Hermann et al. However, Hermann et al. utilize a plurality of alternating bends for the design of their tubular reactor as they state that flow characteristics for polymerization are preferred in helically wound tubular reactors as compared to flow characteristics in straight tubular reactors.

Other configurations are also known for continuous polymerization. Most of these configurations, however, emphasize internal mixing of the polymerizing composition. For example, U.S. Pat. No. 4,016,348 discloses a reactor process and apparatus for continuous polymerization of styrene to a low residual monomer content in a series flow reactor, wherein the reactor contains internal stationary devices to laterally mix the styrene as it proceeds within the reactor.

U.S. Pat. No. 4,110,521 discloses a continuous polymerization apparatus and process for the production of water-soluble polymers. The apparatus and process employ a tubular reactor that contains static mixers. A stated object thereof is to produce polymers of uniform molecular weight and molecular weight distributions.

U.S. Pat. No. 4,287,317 discloses a continuous process for producing rubber-modified methyl methacrylate syrup. The syrups produced therein are stated to be suitable for producing methyl methacrylate cast sheets or molding materials superior in impact resistance. The syrups are also stated to be useful as the major component of polymerizable adhesives or paints. Stirring of the reactants during processing is said to achieve complete mixing.

U.S. Pat. No. 4,383,093 discloses a tubular polymerization reactor having a tubular reaction space with a length-to-diameter ratio of 20:1 or more and a rotary conveying member disposed within the reaction space. The rotary conveying member is of a tubular coil-like shape.

Referenced in U.S. Pat. No. 4,383,093, also emphasizing the importance of a relatively large length-to-diameter ratio, but not using internal mixing apparatus, is U.S. Pat. No. 3,310,600. Reactors described therein are those permitting rapid removal of the heat of polymerization. Suitable reactors are stated to be preferably coiled or they may consist of concentrically arranged twin tubes that are internally and externally cooled by a cooling medium. It is stated to also be possible to arrange multiple numbers of such individual tubes in parallel to form large reactors. The reactors therein are stated to facilitate production of twenty kilograms or more of ethylene oligomers per liter of reactor per hour.

In view of environmental and safety concerns as well as the ever-present desire to optimize production efficiency, alternative apparatus for production of partially polymerized compositions, such as those on which many adhesives are based, are desired. While many apparatus for continuous processing of partially polymerized compositions to polymers are known, there is a need for apparatus to facilitate continuous processing of monomers to partially polymerized compositions.

It is also desirable to provide apparatus capable of producing partially polymerized compositions that are further polymerizable to polymers having a desired polydispersity. For example, while a narrow molecular weight distribution (i.e., polydispersity) such as that achieved with polymerization reactors described in U.S. Patent Publication No. 2006/0036047 may be adequate for polymers used in certain applications (e.g., binders for paint compositions as described therein), other applications benefit from polymers having a broad molecular weight distribution. One such application is that of pressure sensitive adhesives. Thus, alternative apparatus that facilitate preparation of polymers having a broader molecular weight distribution are also desired.

### BRIEF SUMMARY OF THE INVENTION

Advantageously, apparatus of the invention facilitate and impart process efficiencies not previously obtained due to the continuous nature of the multiple steps associated with use of the apparatus. Apparatus of the invention are particularly adapted for partial polymerization of monomers.

According to one aspect of the invention, an apparatus for continuous production of a partially polymerized composition comprises: a reactor for formation of monomer to be partially polymerized; and a polymerization reactor for continuously receiving the monomer to be partially polymerized from the reactor in which it is formed and partially polymerizing the monomer, wherein the polymerization reactor comprises a heating portion and an optional cooling portion.

In one embodiment, the heating portion of the polymerization reactor comprises a tubing network compressed within a heat transfer medium. In another embodiment, the heating portion of the polymerization reactor comprises a tubing network that consists essentially of a straight tube. In either embodiment, the tubing network is essentially free of internal mixing apparatus in preferred embodiments.

In an exemplary embodiment, the cooling portion of the polymerization reactor comprises a tubing network within a cooling medium. In a further embodiment, the tubing network of the cooling portion has dimensions approximating dimensions of a tubing network of the heating portion.

In a further embodiment, the reactor for formation of the monomer comprises an esterification reactor. Still further, the apparatus may comprise a partial condenser for vaporization of water by-product received from the reactor for formation of the monomer via a first conduit and/or a total condenser for removal of the water by-product via a second conduit and, optionally, condensation and return of monomer reactants to the reactor for formation of the monomer via a third conduit and/or a first distillation column for receipt of effluent from the reactor for formation of the monomer and distillation thereof, wherein monomer reactants distilled therefrom are optionally recycled to the reactor for formation of the monomer and separated from the monomer and other components. When the apparatus comprises a first distillation column, it may further comprise a second distillation column for receipt of the monomer and the other components from the first distillation column and separation of the monomer from the other components via a conduit.

According to another aspect of the invention, an apparatus for continuous production of a partially polymerized composition comprises: a polymerization reactor for continuously receiving monomer to be partially polymerized and for partially polymerizing the monomer therein, wherein the polymerization reactor comprises an essentially straight tube for a heating portion and wherein the heating portion is essentially free of internal mixing apparatus.

In further embodiments of either aspect of the invention, the polymerization reactor comprises a plug flow reactor. In still further embodiments, the heating portion of the polymerization reactor comprises a tubing network within a heat transfer medium. According to one aspect of this embodiment, the tubing network has a ratio of surface area to volume of at least about 0.8/cm (2/inch), more preferably a ratio of surface area to volume of at least about 2.4/cm (6/inch), even more preferably a ratio of surface area to volume of at least about 3.2/cm (8/inch), and most preferably a ratio of surface area to volume of at least about 6.3/cm (16/inch).

In an exemplary embodiment, the heating portion of the polymerization reactor according to either aspect of the invention is capable of both supplying heat for partially polymerizing the monomer and effectively dissipating excess heat resulting from any runaway exothermic reaction. In a further exemplary embodiment, the heating portion comprises at least one outward projection that facilitates heat transfer.

### BRIEF DESCRIPTION OF THE SEVERAL VIEWS OF THE DRAWINGS

FIG. 1 is a schematic representation of exemplary processing steps including a stage of partial polymerization using apparatus of the present invention.

FIG. 2A is a schematic representation of an exemplary polymerization reactor according to the present invention, wherein the polymerization reactor comprises a coiled tubing network.

FIG. 2B is a schematic representation of an exemplary polymerization reactor according to the present invention, wherein the polymerization reactor comprises an essentially linear tube.

FIG. 2C is a schematic representation of a further exemplary polymerization reactor according to the present invention, wherein the polymerization reactor comprises at least one outward projection to facilitate heat transfer.

FIG. 3 is a schematic representation of a method of utilizing apparatus of the present invention for continuous preparation of (meth)acrylate syrup.

### DETAILED DESCRIPTION OF THE INVENTION

The present invention relates to apparatus and related methods for continuous production of partially polymerized compositions and, optionally, polymers therefrom. In an exemplary embodiment, apparatus of the invention facilitate formation of a partially polymerized composition via a continuous process, beginning with preparation of monomer through at least partial polymerization of that monomer.

The present specification makes reference to terms that are described below for convenience of the reader.

As used herein, “(meth)acrylate” refers to both methacrylate and acrylate.

As used herein, “(meth)acrylic acid” refers to both methacrylic acid and acrylic acid.

As used herein, “continuous” refers to a process that is essentially uninterrupted in time and space from a beginning reference point to an ending reference point. In an exemplary embodiment, continuous processes enabled by apparatus of the invention have a beginning reference point preceding formation of monomer and an ending reference point that is no earlier in the process than the point at which a partially polymerized composition, such as a (meth)acrylate syrup, is formed therefrom.

As used herein, “syrup” refers to a partially polymerized composition comprising a mixture of at least one monomer and the polymerization product thereof.

As used herein, “complete conversion” means about 100% of the stoichiometric amount of reactants are reacted, or converted, into their reaction product (i.e., polymer). This percentage of available reactants does not include amounts exceeding stoichiometric quantities of any of the reactants necessary to produce the polymer under the reaction conditions.

As used herein, “near complete conversion” means at least about 90% of the stoichiometric amount of reactants are reacted, or converted, into their reaction product (i.e., polymer). This percentage of available reactants does not include amounts exceeding stoichiometric quantities of any of the reactants necessary to produce the polymer under the reaction conditions.

As used herein, “essentially solvent-free” refers to compositions and associated methods comprising no more than about 5% organic solvents or water, more typically no more than about 3% organic solvents or water. Most typically, such systems are completely free of organic solvents and water.

In one embodiment, unlike conventional methods and associated apparatus for polymerization of stock monomers, apparatus of the invention facilitate continuous processing beginning with formation of at least one monomer from precursors thereof. Any suitable chemistries and associated precursors can be used to form the monomer or combinations thereof. Components within apparatus of the invention, and associated methodology for continuous formation of monomer therein, are adapted according to the chemistry and associated reaction mechanism. Once formed, monomer continues to be processed to a partially polymerized composition in apparatus of the invention.

In contrast to conventional batch and many continuous polymerization techniques and apparatus, continuous polymerization of monomer does not automatically proceed to complete conversion when employing apparatus of the invention. Apparatus of the invention and associated methodology advantageously provide the ability to halt polymerization reactions therein at a point prior to complete conversion, and even at a point prior to near complete conversion, of the monomer. Preferably, the polymerization reaction is capable of being halted at a point prior to 90% conversion, more preferably at a point prior to 70% conversion, even more preferably at a point corresponding to less than about 45% conversion, yet even more preferably at a point corresponding to about 5% to about 25% conversion, and still even more preferably at a point corresponding to about 5% to about 15% conversion, of the monomer based on molar weight of the monomer. The point at which the polymerization reaction is halted typically corresponds to the desired viscosity of the partially polymerized composition so formed. Apparatus of the invention are preferably flexibly adapted to accommodate desired results in that regard.

According to one embodiment of apparatus of the invention, a partially polymerized composition (e.g., (meth)acrylate syrup) comprising a coatable viscosity is capable of being formed therein. In order to form a cohesive coating, a coatable composition generally must have a sufficiently high viscosity. Yet, it is also important that the coatable composition has a low enough viscosity so that it can readily flow onto a substrate upon coating. In an exemplary embodiment, coatable compositions formed in apparatus of the invention have a Brookfield viscosity of about 0.2 Pascal-second (200 centipoise) to about 10 Pascal-seconds (10,000 centipoise) when measured at room temperature. A composition's Brookfield viscosity is measurable using equipment and according to methodology known to those of ordinary skill in the art. For example, a rotational viscometer such as those available from Cole-Parmer (Vernon Hills, Ill.) can be used to measure a composition's Brookfield viscosity.

In another embodiment, coatable compositions formed in apparatus of the invention have a Brookfield viscosity of about 5 Pascal-seconds (5,000 centipoise) or less when measured at room temperature. In yet another embodiment, coatable compositions formed in apparatus of the invention have a Brookfield viscosity of about 4 Pascal-seconds (4,000 centipoise) or less when measured at room temperature. For example, coatable compositions formed in apparatus of the invention can have a Brookfield viscosity of about 0.5 Pascal-second (500 centipoise) to about 5 Pascal-seconds (5,000 centipoise) when measured at room temperature. As yet another example, coatable compositions formed in apparatus of the invention can have a Brookfield viscosity of about 1 Pascal-second (1,000 centipoise) to about 3 Pascal-seconds (3,000 centipoise) when measured at room temperature.

Partial polymerization of the monomer to form the coatable composition can be effected in apparatus of the invention using any suitable mechanism. Any desired or required polymerization initiators associated with the mechanism can be introduced prior to or during the stage of partial polymerization in order to effectuate the desired polymerization. Preferably, the apparatus enables combination of polymerization initiator with the monomer prior to the stage of partial polymerization or at least prior to the point where the monomer is heated to the maximum reaction temperature during the stage of partial polymerization. According to this embodiment, the apparatus is configured to then progressively heat the combination of polymerization initiator and monomer to its maximum reaction temperature. In an exemplary embodiment, essentially all of the polymerization initiator is consumed by the time the maximum reaction temperature is reached. Apparatus of the invention are adapted accordingly.

According to one exemplary mechanism, partial polymerization in apparatus of the invention proceeds via free radical polymerization. Any suitable free radical initiator or combinations thereof can be used to effectuate such partial polymerization. As the composition comprising monomer (e.g., (meth)acrylate monomer) and any free radical polymerization initiator or combinations thereof is heated to its maximum reaction temperature, free radicals are progressively generated upon decomposition of the free radical polymerization initiator. The exothermic free radical polymerization reaction is, thus, able to proceed progressively in this embodiment. In addition to the safety benefits realized by the more efficient heat transfer across the reactor in apparatus of the invention, progressive free radical generation facilitates formation of a partially polymerized composition (e.g., (meth)acrylate syrup) and resulting polymer having a relatively broad range of polydispersity (i.e., molecular weight distribution). Particularly when forming (meth)acrylate-based adhesives, a broad range of polydispersity facilitates formation of polymers that can be the basis for adhesives having often-desired pressure sensitive adhesive properties.

In apparatus of the invention, preferably the stage of partial polymerization proceeds in an essentially solvent-free manner. Advantageously, the absence of solvents (i.e., both organic solvents and water) allows smaller and less costly reaction equipment to be used for that stage. In contrast, as discussed in the background of the invention above, safety mandates that relatively large and specially designed reaction equipment be utilized for conventional solvent-based batch polymerization in order to accommodate the large reaction exotherm and solvents. The solvents must also then be removed, which negatively impacts process efficiency.

As compared to batch polymerization techniques and associated apparatus, apparatus facilitating continuous methods according to the invention enable efficient formation of a partially polymerized composition by exposing only a relatively small volume of material at a time to reaction conditions within a reactor during the stage of partial polymerization. This relatively short and low volume reaction advantageously enables a more controlled reaction product and safer reaction conditions, particularly in view of the highly exothermic nature of, for example, the free radically initiated (meth)acrylate polymerization reaction.

For example, during the stage of partial polymerization, residence time within a heated portion of the polymerization reactor is reduced. In an exemplary embodiment, apparatus of the invention are designed so that residence time within a heated portion of the polymerization reactor is less than about thirty minutes, preferably less than about five minutes.

As another example, during the stage of partial polymerization, apparatus of the invention are designed so that a relatively low volume of material is present within the heated portion of the polymerization reactor at any given time. For example, apparatus of the invention are preferably designed so that less than about 10% of continuous volumetric throughput will be present within the heated portion of the polymerization reactor at any given time. Preferably less than about 3%, more preferably less than about 0.5%, of continuous volumetric throughput will be present within the heated portion of the polymerization reactor at any given time. These percentages of continuous volumetric throughput are calculated by dividing volume of the heated portion of the polymerization reactor by volumetric throughput associated with the reactor.

In exemplary embodiments of the invention, the polymerization reactor comprises a plug flow reactor. In one embodiment, the polymerization reactor in apparatus of the invention comprises at least a tubing network within a heat transfer medium. The tubing comprises any suitable material (e.g., stainless steel tubing). The cross-sectional shape of the tubing is essentially circular in an exemplary embodiment, but it can vary as an elliptical, angular, or similar shape in other embodiments of the invention.

No matter what type of tubing is used, preferably the tubing has a relatively large ratio of surface area to volume. In an exemplary embodiment, about 300-460 centimeters (10-15 feet) of tubing having a radius of about 0.6-2.5 centimeters (0.25-1 inch) is employed. Preferably, ratio of surface area to volume is at least about 0.8/cm (2/inch), more preferably at least about 2.4/cm (6/inch), even more preferably at least about 3.2/cm (8/inch), and most preferably at least about 6.3/cm (16/inch). This relatively large ratio of surface area to volume, as well as use of a heat transfer medium described further below, facilitates optimal thermal management.

In a further embodiment, to optimize efficiency of space, the reactor comprises a compressed (e.g., coiled, wound, folded, or otherwise non-linearly positioned) tubing network within a heat transfer medium. However, to simply and efficiently facilitate only partial polymerization of the monomers processed therein, the tubing is essentially straight (i.e., linear) in preferred embodiments. Not only does the use of straight tubing facilitate preparation of the desired partially polymerized composition, but it also imparts efficiency to the overall apparatus design by making its construction less costly and labor-intensive.

Preferably, the tubing is essentially free of internal mixing apparatus. The absence of internal mixing apparatus facilitates partial polymerization of the monomers processed therein as desired. The absence of internal mixing apparatus also facilitates preparation of polymers having a relatively broad molecular weight distribution. Still further, the absence of internal mixing apparatus also imparts efficiency to the overall apparatus design by making its construction less costly and labor-intensive.

To further promote continuous partial polymerization with optimal thermal management and efficiency, the tubing network within the reactor is preferably oriented within a heat transfer medium (i.e., the heated portion) capable of both supplying heat for continuous reaction of monomer to a partially polymerized composition and, for safety reasons, effectively dissipating excess heat resulting from any runaway exothermic reaction. In further embodiments, the tubing comprises one or more outward projections (e.g., such as those typically associated with cooling fins) extending into the heat transfer medium to facilitate more efficient heat transfer.

Exemplary heat transfer mediums include mineral oil and other hydrocarbon oils, as well as other suitable materials known to those of ordinary skill in the art. The type and amount of such heat transfer medium is selected to facilitate the supply of heat needed to partially polymerize the monomer to a desired partially polymerized composition therefrom in continuous reactions. In an exemplary embodiment, the amount of thermal energy required to heat a predetermined amount of monomer to the maximum reaction temperature employed during use of the apparatus for continuous partial polymerization exceeds the amount of thermal energy released by that amount of material during the continuous polymerization reaction that results in the partially polymerized composition. Thus, unlike conventional methodology and associated processing equipment, removing heat created by exothermic polymerization reactions is not a significant and ongoing concern when employing apparatus of the present invention.

In contrast, it is preferred that the apparatus is designed so that thermal energy within the apparatus is used efficiently and safely. Efficiency is optimized by using the heat generated from the exothermic reaction as the thermal energy needed for partial polymerization in continuous processes employing the apparatus. Further, due to optimized design of the apparatus, the amount of heat generated from the exothermic reaction is controlled so that it does not exceed the amount of thermal energy needed to partially polymerize the monomer to the desired viscosity. In this manner, apparatus of the invention facilitate the ability to halt polymerization reactions therein at a point prior to complete conversion, and even at a point prior to near complete conversion, of the monomer.

Depending on the nature of the monomer, elevated pressure (i.e., pressure greater than approximately atmospheric pressure) is not necessary to efficiently react the monomer during the stage of partial polymerization in exemplary apparatus of the invention. A pressure gradient can be used within such apparatus, however, merely to move the reaction mixture therethrough.

Similarly, as compared to many conventional methodologies, highly elevated temperature is also not necessary to efficiently react the monomer during the stage of partial polymerization. In an exemplary embodiment, the stage of continuously polymerizing the monomer to a partially polymerized composition is capable of efficiently proceeding at temperatures of about 150° C. or less in apparatus of the invention. In a further embodiment, the stage of continuously polymerizing the monomer to a partially polymerized composition is capable of efficiently proceeding at temperatures of about 120° C. or less in apparatus of the invention. Polymerization to a partially polymerized composition can occur at a temperature as low as the decomposition or activation temperature of any polymerization initiator used to react the monomer. However, elevating the reaction temperature to a point above the decomposition or activation temperature of any polymerization initiator used promotes a more rapid reaction. Apparatus of the invention preferably allow for adjustment of temperature as so desired.

Once the partially polymerized composition is formed, it can be stored for later processing or continuously supplied to further processing equipment for additional continuous processing. When stored for later use, storage stability can be enhanced by bringing the partially polymerized composition to approximately room temperature (i.e., about 22° C. to about 25° C.) and/or exposing the composition to oxygen in the atmosphere. Thus, according to a further embodiment of apparatus of the invention, the reactor comprises additional tubing positioned within a cooling medium (e.g., chilled water bath) to efficiently cool the partially polymerized composition to the desired temperature (e.g., approximately room temperature). Preferably, a relatively large ratio of surface area to volume is achieved by the use of tubing for the cooling stage as well as within the heated portion of the reactor. While the tubing is compressed in one embodiment, the tubing is essentially straight in other embodiments. In further embodiments, the tubing for the cooling stage comprises one or more outward projections (e.g., such as those typically associated with cooling fins) that facilitate heat transfer.

In an exemplary embodiment, the tubing network of the cooling portion has dimensions approximating dimensions of the tubing network of the heated portion. In a further exemplary embodiment, the tubing positioned within a cooling medium is of the same type and of approximately the same dimensions as the tubing network positioned within the heat transfer medium. This facilitates relatively simple and efficient cooling of the partially polymerized composition.

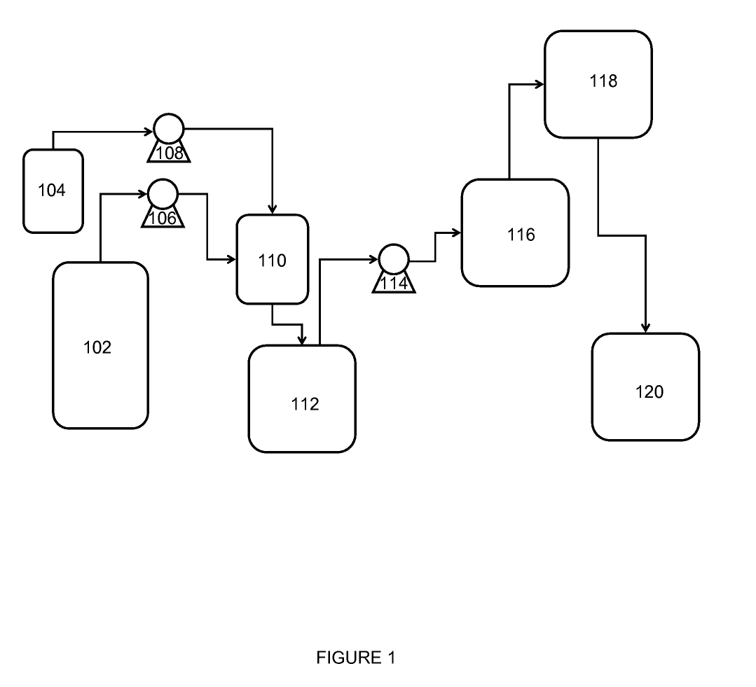

FIG. 1 schematically illustrates exemplary processing steps including a stage of partial polymerization proceeding within a polymerization reactor of apparatus of the present invention. As shown therein, monomer 102 and polymerization initiator 104 are fed through respective meter mixers 106 and 108 for partial polymerization. Optionally, the mixture 110 of monomer 102 and polymerization initiator 104 is mixed using a static in-line mixer. Thereafter, the mixture 110 proceeds through a vessel 112 where the effects of any polymerization inhibitors present are deactivated, when necessary, before being fed through meter mixer 114 and into a polymerization reactor. The polymerization reactor includes a heating portion 116 and a cooling portion 118.

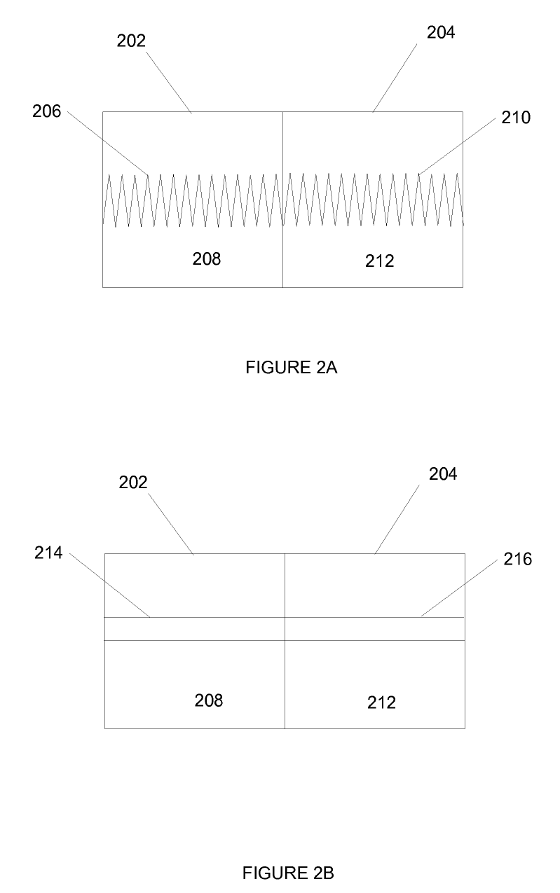

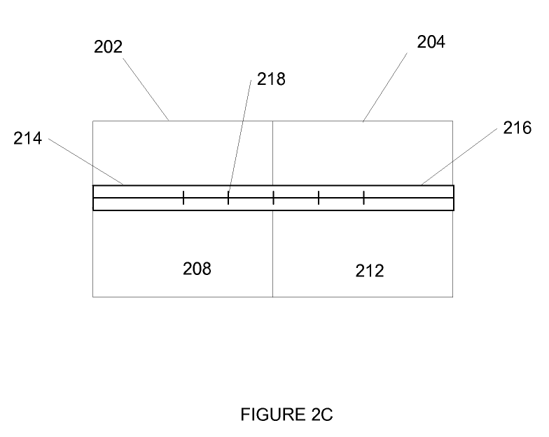

Further details of an exemplary polymerization reactor comprising a coiled tubing network are illustrated in FIG. 2A. As discussed above, the polymerization reactor 200 comprises a heating portion 202 and a cooling portion 204. In this embodiment, the heating portion 202 comprises a coiled tubing network 206 within a heat transfer medium 208. The cooling portion 204 comprises a coiled tubing network 210 within a cooling medium 212.

Further details of an exemplary polymerization reactor comprising an essentially straight tube are illustrated in FIG. 2B. As discussed above, the polymerization reactor 200 comprises a heating portion 202 and a cooling portion 204. In this embodiment, the heating portion 202 comprises an essentially straight tube 214 within a heat transfer medium 208. The cooling portion 204 comprises an essentially straight tube 216 within a cooling medium 212.

In still further embodiments, as illustrated in exemplary FIG. 2C, the heating portion 202 and/or the cooling portion 204 can comprise at least one outward projection 218 to facilitate heat transfer. While an essentially straight finned tube is illustrated in FIG. 2C, recognize that other configurations (e.g., condensed tubing networks) for the heating portion 202 and/or the cooling portion 204 can also comprise such outward projections. In addition, while the outward projections 218 are illustrated along the length of both the heating portion 202 and the cooling portion 204 in FIG. 2C, such outward projection 218 or multiples thereof need not be positioned in both the heating portion 202 and the cooling portion 204.

With reference again to FIG. 1, once partially polymerized in the polymerization reactor, partially polymerized composition 120 is obtained according to the invention. The partially polymerized composition 120 can then be stored for later processing into, for example, an adhesive or it can proceed into additional equipment for further continuous processing into a composition, as desired.

Exemplary embodiments and applications of apparatus of the invention are described in the following non-limiting examples.

### EXAMPLES

### Example 1

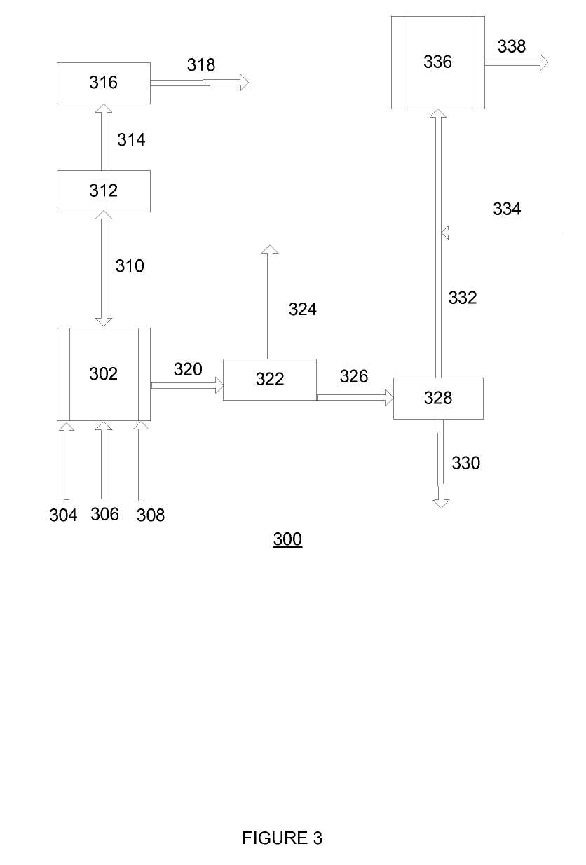

With reference to FIG. 3, a flow diagram 300 exemplifying a method employing apparatus of the invention for continuous preparation of (meth)acrylate syrup is illustrated. A first reactor 302 is continuously supplied with acrylic acid and iso-octanol via conduits 304 and 306, respectively, in a proportion such that iso-octanol is supplied in a molar excess of about 1.1:1 to about 2:1 to that of the acrylic acid. Sulfuric acid is added to the reactants via conduit 308 in an amount such that it is present in about 0.5 weight % to about 5 weight % of the total reactant mixture.

The reactant mixture is continuously mixed while present in the first reactor 302 operating at a reduced pressure of about 50 mmHg to about 250 mmHg. The first reactor 302 (i.e., an esterification reactor) is maintained at a temperature of about 70° C. to about 135° C. as an esterification reaction leads to monomer formation. During this stage, water by-product from formation of monomer passes via conduit 310 through a partial condenser 312 in the gas phase. Thereafter, it passes via conduit 314 through a total condenser 316 before being removed from the process via conduit 318. All other reactants (i.e., acrylic acid, iso-octanol, and/or sulfuric acid) are allowed to condense and re-enter the reaction mixture via conduit 310.

After sufficient time has passed, effluent from the first reactor 302 is pumped via conduit 320 into a first distillation column 322. The first distillation column 322 operates at a reflux ratio of about 0.5-5.0. Within the first distillation column 322, iso-octanol and acrylic acid are distilled off the top via conduit 324 using a reduced pressure of about 50 mmHg to about 150 mmHg and at a temperature of about 80° C. to about 150° C. These reactants are then recycled back for use in the first reactor 302. Iso-octyl acrylate and other components (e.g., any polymerized material, di-iso-octyl ether, catalyst, or reaction by-products containing the catalyst) are removed from the base of the first distillation column 322 via conduit 326 and pumped to a second distillation column 328.

The second distillation column 328 operates at a reflux ratio of about 0.1-3.0. Within the second distillation column 328, iso-octyl acrylate is distilled off the top via conduit 332 using a reduced pressure of about 10 mmHg to about 120 mmHg and at a temperature of about 100° C. to about 150° C. The iso-octyl acrylate is then condensed into a liquid phase and brought to atmospheric pressure and a temperature of about 25° C. to about 100° C.

Once liquified, the iso-octyl acrylate is mixed, in-line, with a free radical polymerization initiator. The free radical polymerization initiator is added via conduit 334 at a relatively low temperature (i.e., below about 70° C.). The free radical polymerization initiator preferably has a ten-hour half-life below about 70° C. Exemplary free radical polymerization initiators include those of azo-type or peroxide-type chemistries. The free radical polymerization initiator is mixed with the iso-octyl acrylate in an amount to maintain a concentration of free radical polymerization initiator in iso-octyl acrylate of about 10 ppm to about 50 ppm.

The mixture of iso-octyl acrylate and free radical polymerization initiator is then routed into a second reactor 336 to partially polymerize the iso-octyl acrylate. The second reactor 336 is maintained at a temperature of about 70° C. to about 120° C. After conversion of about 5% to about 50% of the iso-octyl acrylate, the reaction is suspended by cooling the mixture to about room temperature and exposing the mixture to the atmosphere while exiting the second reactor 336 via conduit 338.

### Example 2

A pilot glass reactor, such as those sold using product designation “PRG-7010-01” from Prism Research Glass (Raleigh, N.C.), having a capacity of 15 liters was jacketed and heated using mineral oil to 100° C. and an operating pressure of 100 mmHg. The first glass reactor was continuously supplied with acrylic acid at a rate of 216 grams per hour (g/hr) (3 moles per hour). Simultaneously, iso-octanol was continuously supplied to the first glass reactor at a rate of 455 g/hr (3.5 moles per hour). Sulfuric acid was continuously supplied to the first glass reactor at a rate of 13.7 g/hr (0.14 moles per hour) to maintain a concentration of sulfuric acid in the reactor of 2% of the total weight.

The reaction was allowed to proceed for three hours before material began to be drawn from the reactor. During this time, water by-product from formation of monomer passed through a partial condenser (maintained at a pressure of 100 mmHg and a temperature of 80° C.) and then a total condenser (maintained at a temperature of 25° C.) before being removed from the process. All other reactants (i.e., acrylic acid, iso-octanol, and/or sulfuric acid) were allowed to condense and re-enter the reaction mixture via a conduit. During the three-hour reaction time period, a total of 169 grams of water and iso-octanol was collected.

At the end of the three-hour reaction time period, effluent from the reactor was pumped at a rate of 589 g/hr into a first distillation column via a conduit. Within the first distillation column, iso-octanol and acrylic acid were distilled off the top of the first distillation column using a reduced pressure of 98 mmHg and a temperature of 138° C. These reactants were then transported back to the first reactor at a rate of 47 g/hr. Iso-octyl acrylate and heavy products (e.g., any polymerized material or di-iso-octyl ether) were removed from the base of the first distillation column and pumped to a second distillation column at a rate of 507 g/hr via a conduit.

Within the second distillation column, iso-octyl acrylate was distilled off the top (at a pressure of 2.7 kPa (20 mmHg) and at a temperature of 150° C.). The iso-octyl acrylate was then condensed into a liquid phase and brought to atmospheric pressure and a temperature of 103° C.

Once liquified, the iso-octyl acrylate was mixed, in-line, with V-70, an azo free radical polymerization initiator having a ten-hour half life temperature of 30° C., available from Wako Chemicals USA, Inc. (Richmond, Va.), resulting in an iso-octyl acrylate solution containing 0.05% by weight free radical polymerization initiator. The mixture of iso-octyl acrylate and free radical polymerization initiator was then routed at a rate of 27 g/hr into a second reactor to partially polymerize the iso-octyl acrylate.

The second reactor was maintained at a temperature of 110° C. The second reactor comprised a first 3.7-meter (12-foot) length of coiled stainless steel tubing having an inside diameter of 6.4 mm (0.25 inch) and a wall thickness of 0.5 mm (0.02 inch). The first length of coiled tubing was immersed in mineral oil maintained at a temperature of 110° C. After passing through the first length of heated tubing, the iso-octyl acrylate syrup passed into a second 3.7-meter (12-foot) length of coiled stainless steel tubing also having an inside diameter of 6.4 mm (0.25 inch) and a wall thickness of 0.5 mm (0.02 inch). The second 3.7-meter (12-foot) length of coiled tubing was maintained at a temperature of 10° C. by its placement within a circulated water bath maintained at that temperature. After conversion of 12% of the iso-octyl acrylate to 4 Pascal-seconds (4,000 centipoise) iso-octyl acrylate syrup, the reaction was suspended by cooling the mixture to 22° C. and exposing the mixture to the atmosphere.

### Example 3

(Meth)acrylate syrup prepared according to a method of the invention described in Example 2 was mixed with acrylic acid in a weight ratio of 90:10. To this mixture was added about 0.5-2.0% by weight photoinitiator (IRGACURE 819, a bis-acyl-phosphine oxide photoinitiator with a maximum absorption in the range of about 360-390 nanometers available from Ciba Specialty Chemicals Inc. of Tarrytown, N.Y.), and about 0-1.2% by weight stannous octoate catalyst, based on total syrup weight. The mixture was coated onto a 50 μm-thick (2 mil-thick) polyethylene terephthalate substrate to a thickness of about 25-50 μm (1-2 mils) and laminated with a transparent 75 μm-thick (3 mil-thick) polyethylene terephthalate release to form a transfer tape enclosed within an inert environment. The laminated sample was then placed about 8-18 cm (3-7 inches) away from a bank of BLB bulbs having a maximum spectral output of about 354 nanometers (e.g., such as F8T5 ultraviolet bulbs available from commercial sources such as McMaster-Carr of Princeton, N.J.) and irradiated from about 45 seconds to about 3 minutes to form a pressure sensitive adhesive.

Various modifications and alterations of the invention will become apparent to those skilled in the art without departing from the spirit and scope of the invention, which is defined by the accompanying claims. For example, the presence of minor interruptions (for example, in time or space) in a process employing apparatus of the invention does not necessarily render the process discontinuous and the apparatus outside the scope of the present invention. It should also be noted that steps and stages recited in any method claims below do not necessarily need to be performed in the order that they are recited. Those of ordinary skill in the art will recognize variations in performing the steps and stages from the order in which they are recited. In addition, the lack of mention or discussion of a feature, step, stage, or component provides the basis for claims where the absent feature or component is excluded by way of a proviso or similar claim language.

Further, as used throughout, ranges may be used as shorthand for describing each and every value that is within the range. Any value within the range can be selected as the terminus of the range. Similarly, any discrete value within the range can be selected as the minimum or maximum value recited in describing and claiming features of the invention. Other variations are recognizable to those of ordinary skill in the art.

1. An apparatus for continuous production of a partially polymerized composition, comprising:
a reactor for formation of monomer to be partially polymerized; and
a polymerization reactor for continuously receiving the monomer to be partially polymerized from the reactor in which it is formed and partially polymerizing the monomer, wherein the polymerization reactor comprises a heating portion and an optional cooling portion.

2. The apparatus of claim 1, wherein the reactor for formation of the monomer comprises an esterification reactor.

3. The apparatus of claim 1, further comprising a partial condenser for vaporization of water by-product received from the reactor for formation of the monomer via a first conduit.

4. The apparatus of claim 3, further comprising a total condenser for removal of the water by-product via a second conduit and, optionally, condensation and return of monomer reactants to the reactor for formation of the monomer via a third conduit.

5. The apparatus of claim 1, further comprising a first distillation column for receipt of effluent from the reactor for formation of the monomer and distillation thereof, wherein monomer reactants distilled therefrom are optionally recycled to the reactor for formation of the monomer and separated from the monomer and other components.

6. The apparatus of claim 5, further comprising a second distillation column for receipt of the monomer and the other components from the first distillation column and separation of the monomer from the other components via a conduit.

7. The apparatus of claim 1, wherein the polymerization reactor comprises a plug flow reactor.

8. The apparatus of claim 1, wherein the heating portion of the polymerization reactor comprises a tubing network within a heat transfer medium.

9. The apparatus of claim 8, wherein the tubing network has a ratio of surface area to volume of at least about 0.8/cm (2/inch).

10. The apparatus of claim 8, wherein the tubing network has a ratio of surface area to volume of at least about 2.4/cm (6/inch).

11. The apparatus of claim 8, wherein the tubing network has a ratio of surface area to volume of at least about 3.2/cm (8/inch).

12. The apparatus of claim 8, wherein the tubing network has a ratio of surface area to volume of at least about 6.3/cm (16/inch).

13. The apparatus of claim 8, wherein the tubing network is compressed within the heat transfer medium.

14. The apparatus of claim 8, wherein the tubing network consists essentially of a straight tube.

15. The apparatus of claim 8, wherein the tubing network is essentially free of internal mixing apparatus.

16. The apparatus of claim 1, wherein the heating portion of the polymerization reactor is capable of both supplying heat for partially polymerizing the monomer and effectively dissipating excess heat resulting from any runaway exothermic reaction.

17. The apparatus of claim 1, wherein the cooling portion of the polymerization reactor comprises a tubing network within a cooling medium.

18. The apparatus of claim 17, wherein the tubing network of the cooling portion has dimensions approximating dimensions of a tubing network of the heating portion.

19. An apparatus for continuous production of a partially polymerized composition, comprising:
a polymerization reactor for continuously receiving monomer to be partially polymerized and for partially polymerizing the monomer therein,
wherein the polymerization reactor comprises an essentially straight tube for a heating portion and wherein the heating portion is essentially free of internal mixing apparatus.

20. The apparatus of claim 19, wherein the heating portion comprises at least one outward projection that facilitates heat transfer.
